(19) United States
(12) Patent Application Publication
(10) Pub. No.: US 2010/0043797 A1
(43) Pub. Date: Feb. 25, 2010

(54) COMBINED REBREATHER BAIL OUT VALVE AND LOOP VOLUME VALVE

(76) Inventor: Alexander Roger Deas, Dalkeith (GB)

Correspondence Address: Maria Nilova;PATENTICA LLC, Office 303, 51, Sadovaya Street, Saint Petersburg, 190068, RU

(21) Appl. No.: 12/542,895

(22) Filed: Aug. 18, 2009

(30) Foreign Application Priority Data
Aug. 20, 2008 (GB) GB0815141.7
Jan. 19, 2009 (GB) GB0900784.0

(51) Int. Cl. A62B 9/02

(52) U.S. Cl. 128/205.24

(57) ABSTRACT

A device that combines the function of a rebreather bail out valve and loop volume valve (also known as an Automatic Diluent Valve), using a single pressure or flow regulator, with preferred embodiments providing a bipolar or tripolar action. The device can provide an automatic loop shut off capability.

### CROSS-REFERENCE TO RELATED APPLICATIONS

This application claims the benefits from earlier filed applications GB0815141.7 of Aug. 20, 2008 and GB0900784.0 of Jan. 19, 2009. The contents of these applications are hereby incorporated by reference and in their entirety.

### BACKGROUND OF THE INVENTION

Rebreathers are a type of life support equipment that recirculates a user's gas by passing expired gas through a breathing loop comprising counterlungs, a carbon dioxide scrubber and a means to inject oxygen to make up for that lost through metabolism or vented from the loop, then back for the user to inhale.

Rebreathers for diving applications have a means to add a make-up-gas to the breathing loop, so the loop pressure is kept close to the ambient. This make-up-gas may be added using a manual injector, or more commonly by an automatic loop volume valve that triggers when the loop pressure is below a predefined threshold with respect to the ambient: a typical value is −20 mbar relative to the ambient pressure. This automatic loop volume valve (LVV) is sometimes called an automatic diluent valve, though the make-up-gas does not dilute anything—it is provided to maintain loop volume.

The position of the automatic loop volume valve is very important: the diver's lung centroid, the most extreme corner of the counterlungs and the over-pressure valve, need to be within 20 cm of each other, if the cracking pressure on the automatic loop volume valve is −20 mbar, otherwise in certain positions there will be either a freeflow of gas or the loop pressure will exceed the maximum permitted by European safety standards.

In addition to the Loop Volume Valve, rebreathers for diving applications usually have some form of bail out valve: this is a valve fitted to the mouthpiece that allows the diver to change from breathing off the closed loop, to breathing from an Open Circuit second stage regulator. A bail out valve has a cracking pressure of a few millibar, around a tenth that of a Loop Volume Valve.

The use of Bail Out Valves is well established, with several dozen different designs in common use and commercially available. One of the earliest of these is described in U.S. Pat. No. 5,127,398, and similar units are described or inferred by Bayron in U.S. Pat. No. 5,74,6199, Matsuoka in U.S. Pat. No. 6,681,766 and Chen in US 2002157699.

Attempts have been made to combine the bail out valve and loop volume valve, notably by Lars Erik Frimann in WO 2007/126317. The method proposed by Frimann is to restrict the gas path to the diaphragm of the regulator that comprises the valve, such that in bail out mode there is a large gas path to the diaphragm, and in closed circuit mode there is a small area. Unfortunately this method does not work, because there is no difference in the cracking pressure from restricting the gas path to the diaphragm. The cracking pressure of a SCUBA second stage regulator is defined by:
1. The intermediate pressure between the first stage regulator and the second stage.
2. The area of the gas orifice that is closed by the valve seat exposed to the intermediate pressure.
3. The strength of the spring that presses the valve seat over the gas orifice.
4. The leverage ratio from the valve seat to the diaphragm; this is usually a mechanical lever but in some cases this is a pneumatic level using a pilot valve.
5. The area of the diaphragm that acts on the lever, against the pressure of the spring to open the diaphragm orifice.

Restricting the gas flow to the diaphragm from the diver causes a delay in actuating the demand valve, but no significant change in the cracking pressure of the valve: there is no gas flowing from the diaphragm to the diver—it is pressure activated not flow activated. Moreover, when the demand valve in the Frimann device supplies gas, pressure tends to build up that shuts the diaphragm prematurely. As a result, the Frimann patent does not work in any manner than can meet the safety standards, requiring around a 10:1 ratio in the cracking pressure between closed circuit and open circuits modes of operation, and freedom of oscillation in open circuit mode.

Various other companies that have been in contact with Mr Frimann have displayed and exhibited combined LVV and Bail Out Valves, including Ambient Pressure Diving Ltd and Poseidon AS. A person skilled in the art or SCUBA equipment design and pneumatics on examining the valves exhibited by these companies can see that the Ambient Pressure Diving valve is an implementation of the Frimann idea. The Poseidon valve in the format displayed and exhibited uses a pilot valve which moves relative to a diaphragm, such that the valve depends on diaphragm displacement—this does not control cracking pressure very well. As the diaphragm does not have any spring other than its own resilience, which is generally very low in order to provide a low cracking pressure in Open Circuit mode, the valve does not provide sufficient cracking pressure in Closed Circuit mode: it will tend to free-flow in certain diver attitudes or positions.

A further problem faced by attempts to combine the loop volume valve and bail out regulator, is that whilst bail out tends to be a large cylinder of gas, typically a 7 to 15 litre cylinder, the make-up-gas comes from a very small cylinder: usually 2 to 3 litres. If a diver bails out onto a 2 litre cylinder at the depths often dived by technical sports divers, namely 80 msw to 120 msw, it would last less than ten breaths. Even at shallower depths, it would last an insufficient period to allow the dive to be aborted safely. The various attempts at combining the bail out and loop volume valve do not address this fundamental problem.

There are still further problems with bail out valves, which are magnified when the bail out valve is combined with an LLV. Fatal accidents have occurred where the diver moved the valve to a position which allowed the bail out valve to work, but did not open the valve fully, with the result that the work of breathing was so high as to become a contributing factor in the mishap. All present bail out valves can be set in a position where the diver has neither bailed out fully, nor is on the loop fully.

Finally, U.S. Pat. No. 6,817,359 describes a loop shut off valve such that when the rebreather is not able to guarantee a safe breathable gas is the breathing loop, then a valve located between the loop volume valve and the counterlungs is closed, thereby emulating the same out of gas experience an Open Circuit diver has when their cylinder is empty. It is highly advantageous to locate that automatic shut off valve at the mouthpiece, such that if there is any failure of breathing loop the whole loop is shut off, including the hoses.

### BRIEF SUMMARY OF THE INVENTION

### Object of the Present Invention

It is an object of the present invention to provide a control device combining a loop volume valve and a bail out valve to reduce the cost of producing rebreathers and to enable the diver to verify that the bail out valve is actually operational before the diver needs to call on it.

It is a further object of the current invention to provide a polarised action of the bail out valve such that the diver is either bailed out and breathing from the bail out valve, or is breathing on the breathing loop, or in the case of the tripolar device then both valves are shut. The further objective is to prevent a partial operating state.

It is a further object of some embodiments of the current invention to provide an automatic loop shutoff right at the mouthpiece.

### Summary of the Present Invention

In one aspect, the present invention provides a control device comprising a rebreather mouthpiece, a rebreather inhale and exhale port with a one way valve on each port, a pneumatic demand valve, a shut-off means for closing off the rebreather inhale port, wherein the control device further comprises adjusting means for adjusting the cracking pressure of the demand valve by changing the diaphragm active area or the leverage ratio of the diaphragm to valve seat pressures synchronously with closing off or opening the rebreather inhale port. The present invention changes the cracking pressure of an Open Circuit second stage regulator that is combined with a rebreather loop mouthpiece by varying one or more of four of the five links in the chain from the intermediate pressure, through the orifice opening onto the valve seat, the spring pressure or the leverage ration from the spring actuator to the diaphragm, synchronously with opening and closing the rebreather loop.

In one embodiment of the invention, the means to close off the rebreather inhale port also closes off the rebreather exhale port and opens an open circuit exhale port, in a synchronous manner.

In one embodiment of the invention, the port between the diver's mouth and the internal gas space of the device is angled to enable the gas from the diver's mouth to flow at an angle between 5 degrees and 35 degrees below the horizontal into the internal gas space of the device.

In one embodiment of the invention, there is a curved surface within the mouthpiece barrel to enable a major part of the gas going to the diver to flow from the rebreather inhale one way valve to the diver without meeting entirely a 90 degree wall, or from the diver to the exhale one way valve without the major part of the gas flow striking an obstruction at 90 degrees to the gas flow.

In one embodiment of the invention, the shut off means for closing off the inhale rebreather port is spring loaded and has a retaining latch such that it has just two or three stable positions and cannot remain in an intermediate position without constant attention by the user.

In another embodiment of the invention, the shut off means for closing off the inhale rebreather port is activated using a motor, including a solenoid or DC motor or AC motor or Stepper motor or Piezo motor or pneumatic device, such that a controller or safety monitor is able to close the rebreather inhale breathing path.

In one embodiment of the invention, the diaphragm to the demand valve can be depressed or activated using a button that causes the device to be purged of water in whole or in part when a gas supply is connected and the button is depressed.

In one embodiment of the invention, the control device is further provided with a means to mitigate the risk of free flow by using a vortex of water between an outer cover and an inner cover such that the vortex applies a pressure to a purge button that equalises in whole or in part the pressure applied to the purge button by the same water.

In one embodiment of the invention, the control device is further provided with a means to change the maximum flow rate from the demand valve synchronously with the change from closed to open circuit, such that the maximum flow rate in open circuit is a multiple of the maximum flow rate in closed circuit.

In another aspect of the invention, a re-breather control device is provided, the control device comprising a re-breather mouthpiece, a re-breather inhale and exhale port with a one way valve on each port, a pneumatic demand valve, a shut-off means for closing off the rebreather inhale port, wherein the control device further comprises an adjusting means for adjusting the cracking pressure of the demand valve by changing the demand valve seat spring tension or compression synchronously with closing off or opening the rebreather inhale port.

In one embodiment of the invention, the means to close off the rebreather inhale port also closes off the rebreather exhale port and opens an open circuit exhale port, in a synchronous manner.

In one embodiment of the invention, the port between the diver's mouth and the internal gas space of the device is angled to enable the gas from the diver's mouth to flow at an angle between 5 degrees and 35 degrees below the horizontal into the internal gas space of the device.

In one embodiment of the invention, the shut off means for closing off the inhale rebreather port is spring loaded and has a retaining latch such that it has just two or three stable positions and cannot remain in an intermediate position without constant attention by the user.

Alternatively, in another embodiment of the invention, the shut off means for closing off the inhale rebreather port is activated using a motor, including a solenoid or DC motor or AC motor or Stepper motor or Piezo motor or pneumatic device, such that a controller or safety monitor is able to close the rebreather inhale breathing

In still another aspect of the invention, a re-breather control device comprises a re-breather mouthpiece, a re-breather inhale and exhale port with a one way valve on each port, a pneumatic demand valve, a shut-off means for closing off the rebreather inhale port, and an adjusting means for adjusting the cracking pressure of the demand valve by changing the orifice that applies an intermediate pressure to the demand valve seat, synchronously with closing off or opening the rebreather inhale port.

In one embodiment of the invention, the port between the diver's mouth and the internal gas space of the device is angled to enable the gas from the diver's mouth to flow at an angle between 5 degrees and 35 degrees below the horizontal into the internal gas space of the device.

In one embodiment of the invention, there is a curved surface within the mouthpiece barrel to enable a major part of the gas going to the diver to flow from the rebreather inhale one way valve to the diver without meeting entirely a 90 degree wall, or from the diver to the exhale one way valve without the major part of the gas flow striking an obstruction at 90 degrees to the gas flow.

In one embodiment of the invention, the diaphragm to the demand valve can be depressed or activated using a button that causes the device to be purged of water in whole or in part when a gas supply is connected and the button is depressed.

In one embodiment of the invention, the control device is further provided with a means to mitigate the risk of free flow by using a vortex of water between an outer cover and an inner cover such that the vortex applies a pressure to a purge button that equalises in whole or in part the pressure applied to the purge button by the same water.

In one embodiment of the invention, the control device is further provided with a means to change the maximum flow rate from the demand valve synchronously with the change from closed to open circuit, such that the maximum flow rate in open circuit is a multiple of the maximum flow rate in closed circuit.

### BRIEF DESCRIPTION OF THE DRAWINGS

The invention will now be described by way of example, without limitation to the generality of the invention, and with reference to the following figures:

FIG. 1 is a plan cross sectional view of an example embodiment of the present invention in closed circuit mode, where the body (1) of the combined bail out valve and loop volume valve which will be referred to generally as “the mouthpiece”, has five main subparts:
a port for an inhale hose connection to the rebreather (3), that has within it an inhale flapper valve (5) that prevents the gas in the mouthpiece from flowing back into the inhale hoses attach to the inhale port (3). The surfaces the gas encounters are shaped in this embodiment to avoid any abrupt changes that would increase the breathing resistance, with flow management features (7).
a port for an exhale hose connection to the rebreather (9), that has within it an exhaust flapper valve (11) that prevents gas flowing from the exhaust hoses back into the mouthpiece,
a rotating barrel (13) that has holes in it to allow the gas to flow from the inhale port (3) to the diver's mouthpiece bite (15), and from the diver's mouthpiece bite (15) to the exhaust port (9) when the device is in the closed circuit mode, and which shuts off at least the inhale port (3) and in this embodiment it shuts off also the exhale port (9) when the device is in open circuit mode. The barrel also contains a cam surface (17) that acts on a translator to tension a spring (21) that provides the reaction force to keep a valve seat on to the valve orifice in a second stage demand regulator (23).
A SCUBA second stage regulator, including a lever—in this case a mechanical level (25) though some valves use pneumatic pilot valve leverage, from a force that is applied to diaphragm (27), such that when the diver applies a sufficient negative pressure at the mouthpiece bite (15), the difference in pressure between the gas space inside the mouthpiece body (1) and that of the ambient water, causes a force that pulls the diaphragm in towards the lever (25), the lever applies a greater force across a shorter distance onto a valve seat assembly (29), lifting the valve seat off an orifice which is connected to a medium pressure gas via a port (31) inside which is normally a sintered filter (33) to prevent particles clogging the port and to minimise the risk of oxygen fire of the valve seat itself from adiabatic compression of the medium pressure gas in the case the gas supply is turned on rapidly. The amount of negative pressure needed to lift the valve seat is a function of the diaphragm (27) area, the leverage offered by the lever (25), the pressure of the valve spring (21) that forces the seat onto the orifice, and the medium gas pressure. This means that when the cam (17) that is part of the barrel (13) changes the tension on the valve spring (21), it changes the cracking pressure of the demand regulator (23). A purge button (35) allows the diver to add gas to the loop automatically, or to remove water from the inside of the mouthpiece by expelling it out of the mouthpiece bite (15). The diaphragm (27) is protected from free flow by a hard plate (37), and a cover (39) which in this embodiment features vortex holes (41) that are at a radial angle in the cover (39) such that water striking the cover (39) swirls around between the cover (39) and the hard plate (37) creating a pressure which tends to push the purge button (35) outwards to equalise the water pressure pressing the button inwards.
An actuator assembly comprising a knob or handle (43 in FIG. 6) trigged by a level (83) that allows a ring (45) to turn along the same axis as the barrel (13), turning the barrel (13). The ring may be the same component as the barrel or may be a separate component, and the ring may have the cam surface (17) or may share it with the barrel, or the barrel may contain the cam surface. In this embodiment a latch spring (47) pushes the a second cam to apply a bias pressure to the ring (45) such that it can exist in only one position unless it is latched in by a latch function (shown on another figure): the result is the device can be in either open circuit mode or in closed circuit mode but cannot remain in any intermediate position or mode unless the diver applies a constant pressure to the knob or handle (43) which is normally performed only for a very short period when the latch is reset. The default position when the latch is disengaged, is Open Circuit bailout in this embodiment.

FIG. 2 is the same as FIG. 1 except that whereas FIG. 1 shows the device according to the present invention in closed circuit mode, in FIG. 2 the device is shown in the Open Circuit position or mode.

FIG. 3 shows a device according to the present invention in a skeleton side view on a diver (53), with a skeleton half mask (51). The mouthpiece on this embodiment is angled such that the passage of gas from the diver to the main body of the device (1) is angled at between 5 degrees and 30 degrees below the horizontal. This is because gas exhaled by the diver, travels between the top of the diver's tongue and the roof of the diver's mouth, which is a curved path that results in gas leaving the mouth in a downwards direction. When the mouthpiece is straight into the mouth, this downwards gas hits the wall of the mouthpiece, causing increased breathing resistance. By adopting an inclined attitude for the mouthpiece, the interface between the main body of the device and diver is optimised. Also in this figure, a soft elastomeric mouthpiece bite (57) holds the diver's teeth (55) apart by between 5 mm and 8 mm to keep the front of the mouth open. An opening of more than 8 mm tends to cause jaw fatigue, and an opening of less than 5 mm causes excessive breathing resistance as the gas crosses the diver's teeth. An exhaust vent whisker (59) keeps exhausted gas in open circuit mode from obscuring the diver's vision. The open circuit exhaust valve (61) is closed off by the barrel (13 in FIGS. 1 and 2), in closed circuit mode but is open via a port in the barrel (13) in open circuit mode. The open circuit valve (61) is of an umbrella type in this embodiment to apply a force keeping the valve shut unless it is venting gas.

FIG. 4 is a side cross section of a device according to the present invention in closed circuit mode, showing most of the same features as in FIGS. 1 and 2, but with additional features including a knob reaction stub (71) to provide a reaction point for the diver to open then main knob by applying a force between the knob (43 in FIGS. 1 and 2) and the reaction stub (71).

FIG. 5 is a side cross section of a device according to the present invention in open circuit mode. The open circuit exhaust valve (61) is shown clearly, as is the fact that the barrel (13) closes off the open circuit exhaust valve when the device is in the closed circuit mode as in this figure.

FIG. 6 is a front view of a device according to the present invention with the diaphragm and all components in front of the diaphragm removed, with the device in closed circuit mode. The vent for an exhaust valve (61) for open circuit mode is at the base of the device. The cam action of the ring (45) on the valve seat assembly (29) can be seen clearly in this figure, especially by comparison with FIG. 7. A latch assembly (83) retains and releases the ring (45) which is held in place by a pin on the latch assembly (83) and rotates under the influence of a torsion spring (47). All component labels are consistent between the figures.

FIG. 7 is a front view of a device according to the present invention with the diaphragm and all components in front of the diaphragm removed, with the device in open circuit mode.

FIG. 8 is an external isometric view of a device according to the present invention in closed circuit mode. The knob (43) on the is triggered by a latch (83) such that a brief activation of the latch causes the ring to rotate, and with it the cam mechanism inside the ring or on the barrel (13 in FIG. 1). The latch can be triggered also by a solenoid (81), to provide an automatic loop shut off function.

FIG. 9 is an external isometric view of a device according to the present invention in open circuit mode, provided for comparison with FIG. 8. The device body (1) has a flow direction arrow (85), in this case showing left to right flow convention: other rebreathers may use right to left flow, in which the arrow is reversed.

FIG. 10 is an isometric view of a cross section through the valve in closed circuit mode that shows how the lever latch (91) can hold the knob (43) using a pin such that when the lever is turned it disengages causing the ring attached to the knob (43) to rotate, along with the barrel (13) to switch the device from closed to open circuit modes. Ports in the barrel (13) such as (95) align with the inhale (3) and exhale (9) ports when in closed circuit mode, and close off these ports in the body (1) when in open circuit mode. There may be O-rings around each port, or as here, simply a tight fit between the barrel (13) and the body (1).

FIG. 11 is an isometric view of a cross section through a device according to the present invention in open circuit mode. The lever latch (91) can be seen in this figure along with the connection between the ring and barrel (13). The ring is fixed to the barrel by a secure fixing (93).

### DETAILED DESCRIPTION OF THE INVENTION

The operation of the invention will be described, by reference to example embodiments without limit to the generality of the invention. For brevity, the examples will assume the user is a diver: it will be apparent from the context how this affects other groups of rebreather users.

The general operation of a device according to the present invention should be apparent from the figures, which are extensive in their coverage.

The present invention switches from one breathing loop to another breathing path with an adjustment of the cracking pressure of a demand regulator such that the cracking pressure in open circuit mode is lower than that in rebreather mode.

The first breathing loop is that of the rebreather, so an inhale port (3) with an inhale flapper valve (5) provides a one way gas route from the counterlungs and scrubber into the device, and an exhale flapper valve (11) in an exhale port (9) provides an exhale path. The diver breathes in and out of a mouthpiece bite (15) which is terminated in a soft elastomeric mouthpiece similar to that on most SCUBA second stage regulators. For rebreather applications the mouthpiece needs to hold the diver's teeth apart, by between 5 mm and 8 mm otherwise a risk of excessive CO2 retention may arise from a higher work of breathing or breathing resistance. In the example embodiment given in the figures, the mouthpiece bite (15) is inclined to pick up the main axis of the exhaled gas from the diver, which is between a horizontal line extending perpendicular to the diver's teeth and a second line that extends from the teeth and is tangential with the chin. Straps or bungee cords may be provided to keep the mouthpiece bite in the diver's mouth, and also to prevent the gas space in the mouthpiece from pushing upwards on the diver's mouth. The gas path through the inhale and exhale ports (3) and (9) are generally both closed off by the barrel when the device is in open circuit mode, though in some applications it may be desirous only to close off the inhale port so the exhale port can be used to clear the breathing loop, recovering its utility for the diver.

The second breathing path is from the mouthpiece to an exhaust valve (61) on exhale, and from a SCUBA demand regulator (31) on inhale. The exhaust valve opening is closed off by the barrel when the device is in closed circuit mode, but open when the device is in open circuit mode, by the use of ports (95) in the barrel (13).

This function of switching between closed circuit and open circuit loops is well known, with many types of bail out valve available commercially.

The novel feature of the present invention is to adjust one of the parameters that define the cracking pressure of the demand valve (31) as the barrel (13) is rotated. This is accomplished by the barrel being fixed to a ring, and either the barrel or the ring, or another equivalent part causing a change in one of the following components:

1. The diaphragm area. The diaphragm area can be changed by applying a cup or contact to the diaphragm such that only a part of it moves. This has been used in some SCUBA regulators such as the Poseidon Jetstream to increase the cracking pressure to avoid free flow: it is a well established method, but has not been applied previously to solve the problem of combined LVV and Bail Out Valves.

2. The lever ratio, or leverage, between the diaphragm and the valve seat. This ration can be altered by changing the fulcrum of the level, such as by using a pin through the lever that moves in a gimbal within the barrel, as the barrel is turned. For example, a pin in a bearing race in the barrel could move up and down the level if the other end of the lever (25) is retained using a similar pin and bearing t the other end.

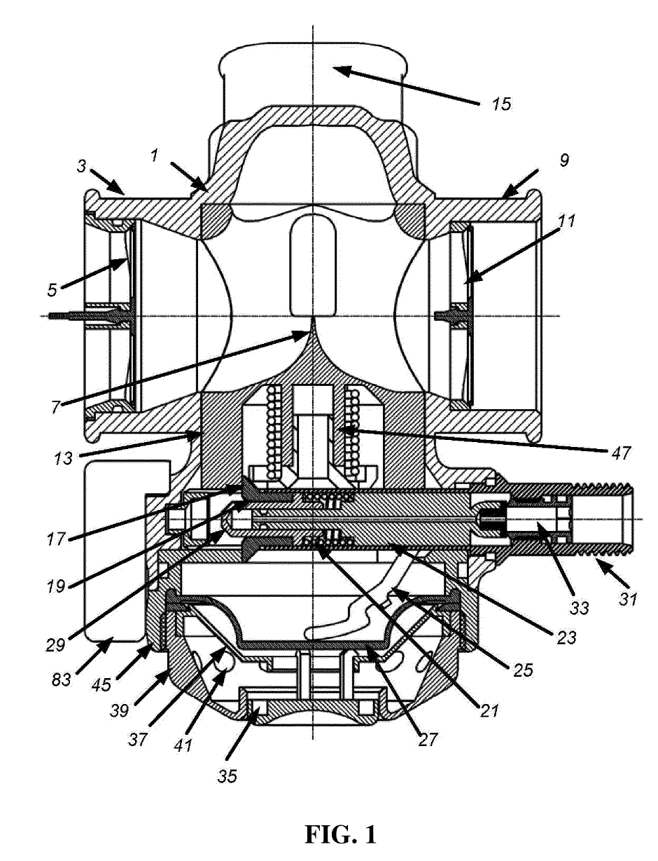

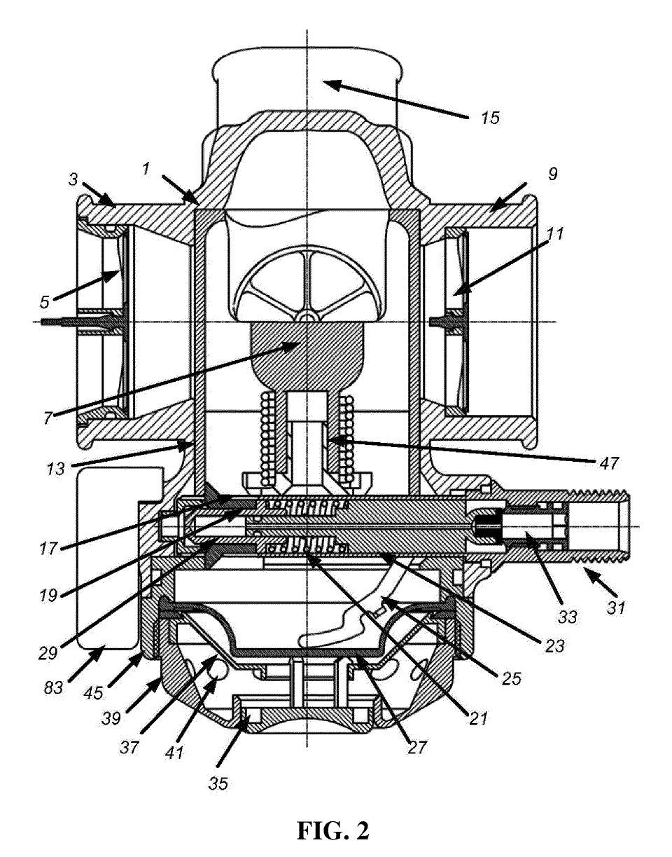

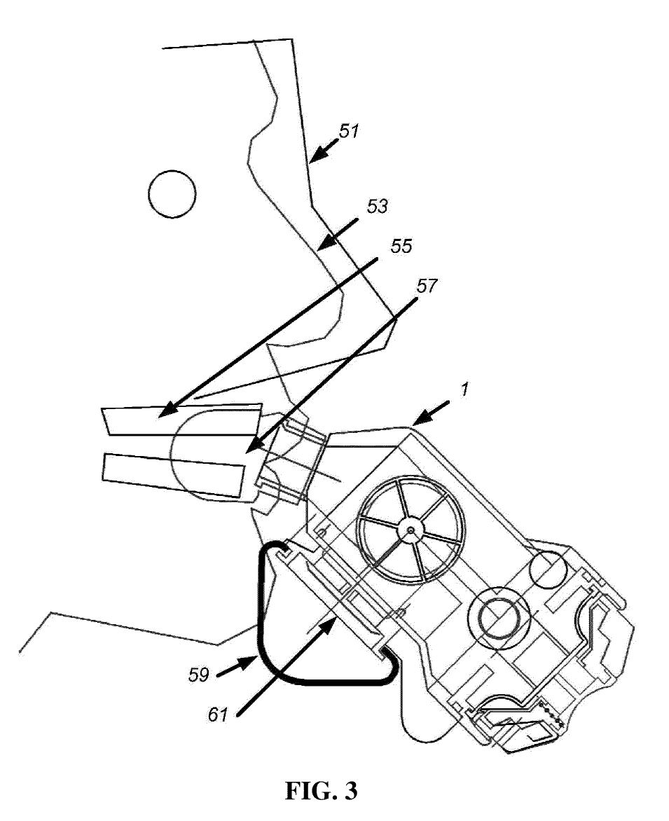

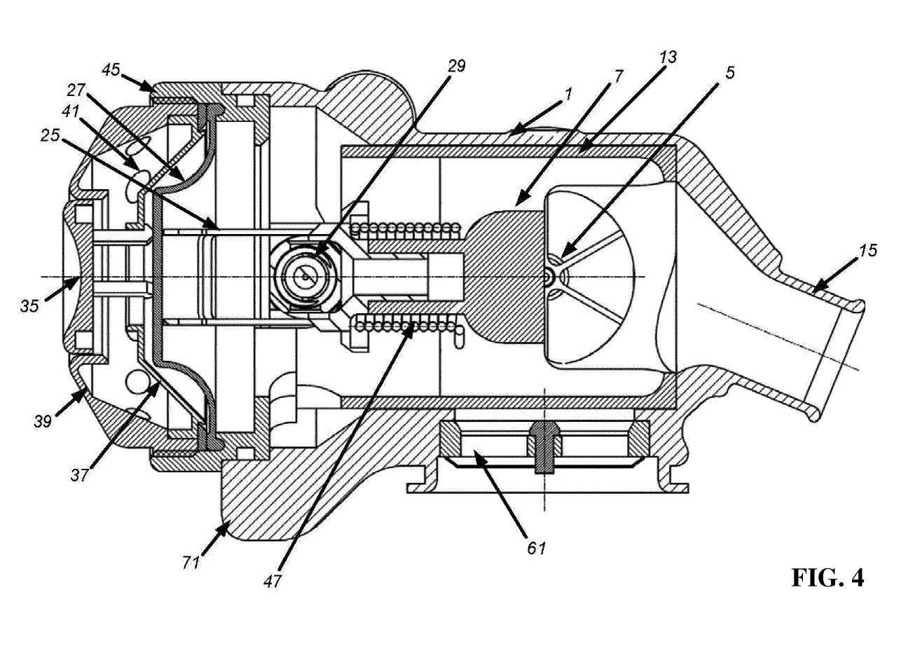

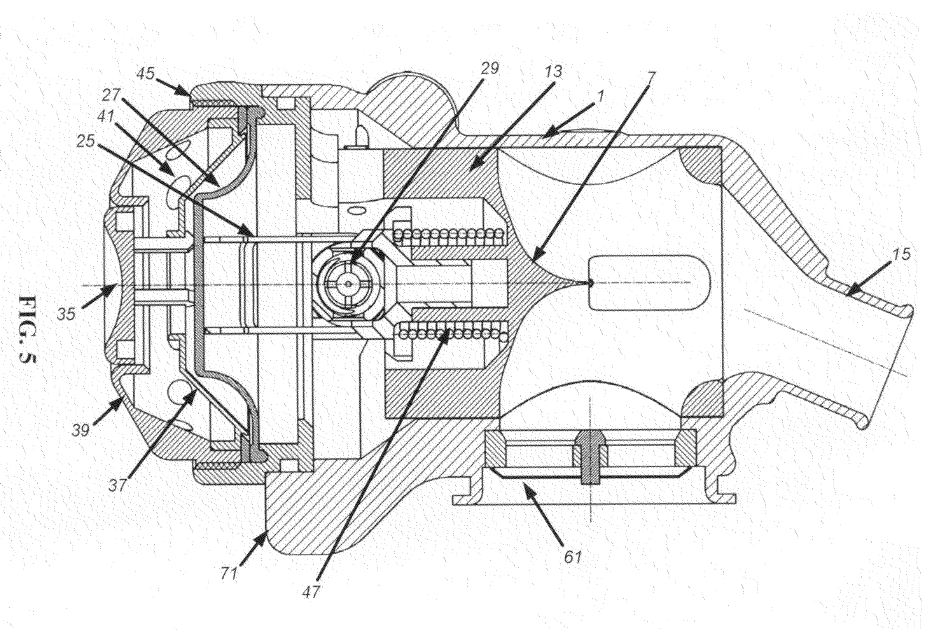

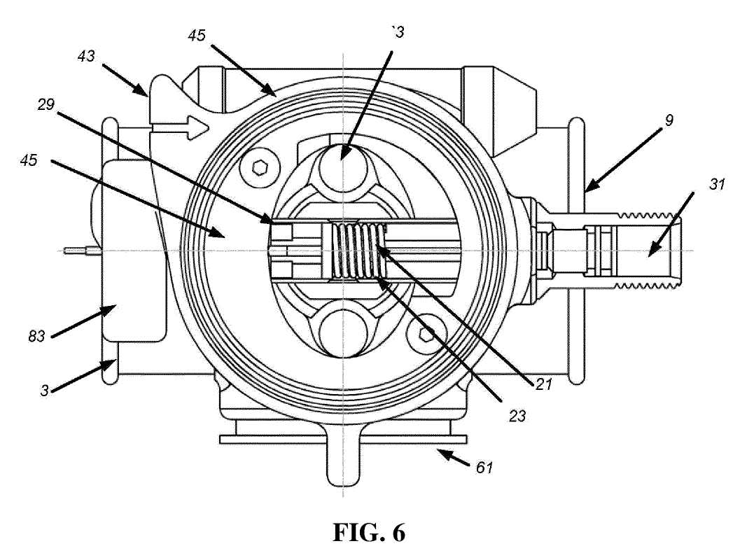

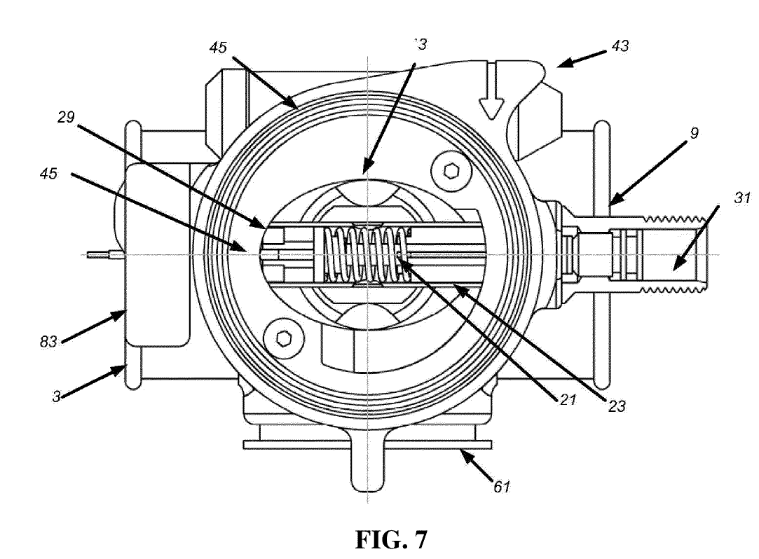

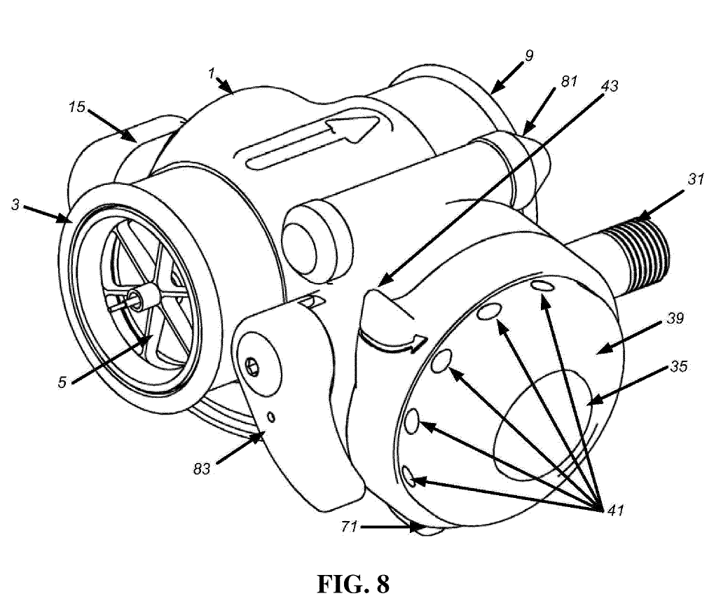

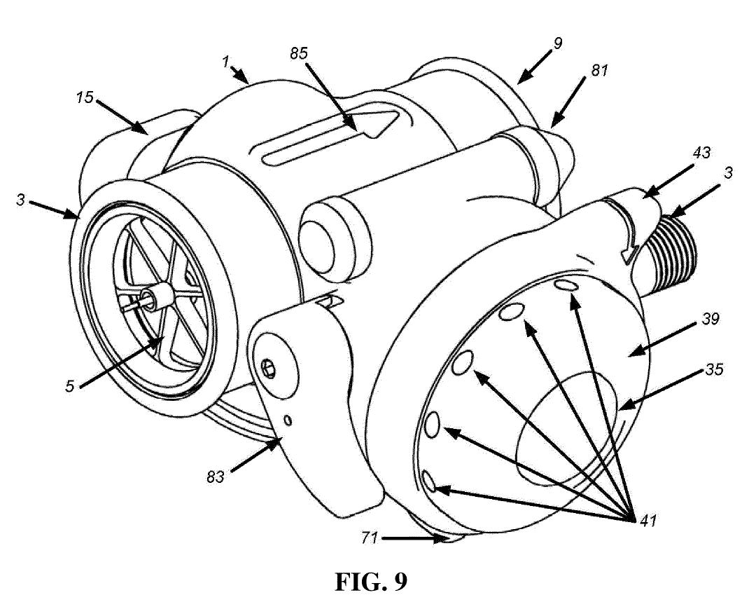

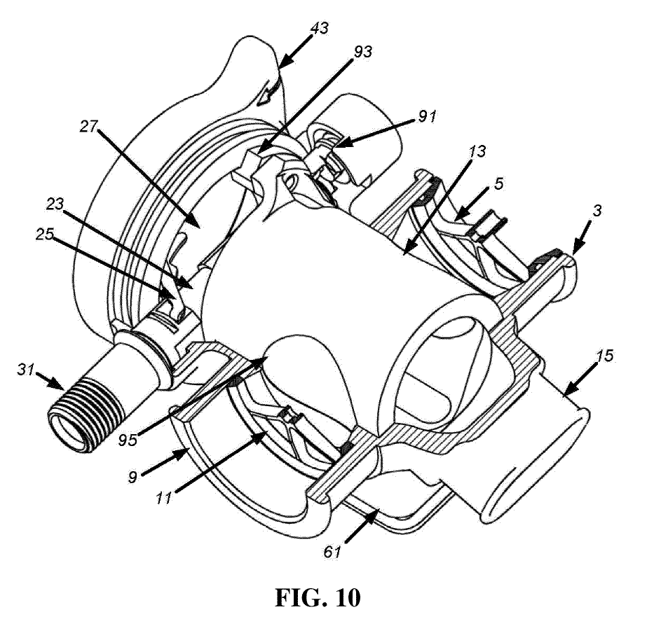

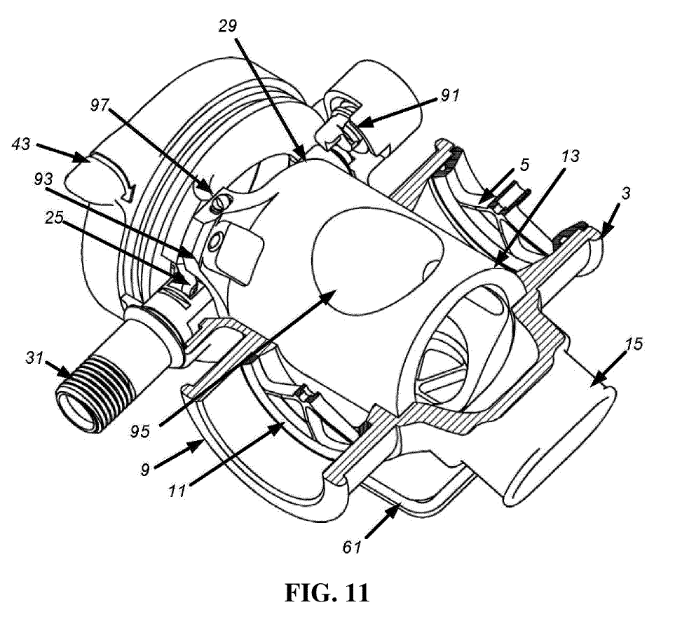

3. The spring force that presses the valve seat assembly (29) of the demand regulator (31) over the orifice supplied with medium pressure gas, can be adjusted by changing the spring length. The use of this method is illustrated in the example embodiments that form FIGS. 1 to 11. In this case a cam on either the ring (45) or the barrel (13) is translated to a change in tension of the demand regulator spring (21).

4. The orifice size of the demand regulator can be adjusted by allowing one of two orifice sizes by using a slotted orifice that forms part of the ring. This requires a high precision of engineering, with close tolerances, but depending on the application can be implemented easily. This method is more problematic to seal than the other methods described, but has the benefit of allowing the maximum flow rate to be changed between the closed circuit and open circuit modes by the change in orifice size: the open circuit requires both a low cracking pressure and a high flow rate that can be achieved using a large orifice, and the converse situation of low flow and high cracking pressure from a small orifice is desired in a closed circuit mode.

In methods 1 to 3 above, the change from closed circuit to open circuit involves not just a change in cracking pressure of the demand valve, and shutting off inhale and exhaust valves, but it is desirable though not essential to change also the maximum flow rate that is supplied by the demand valve. Typically in rebreather closed circuit mode, a flow rate of 100 to 200 litres per minute of gas is desirable and in open circuit a flow rate of 900 to 2500 litres per minute is desirable. The reason for this difference is that if a rebreather with the diver has a gas volume of 15 litres, then a descent in one minute to a depth of 100 msw would require 150 litres of gas to be injected, but at constant depth or in ascent no gas addition is required. In contrast, a diver at 100 msw with a RMV of 90 litres per minute would require 900 litres of gas. This change in maximum flow rate may be accomplished by the barrel having a hole from the demand valve to the breathing space that is obscured to a greater degree when it is in closed circuit mode than in open circuit mode. The hole can be aligned with the flow features (7) to provide a venturii action in the demand valve to further reduce the work of breathing in open circuit mode.

Embodiments of the device may be actuated manually or by automated means, or both, using an electrical solenoid or motor (81), or a pneumatic piston. A simple means to achieve this latching action is to effect of withdrawing the locking pin on the latch (83) such that once triggered the device cannot stay in closed circuit mode but reverts to open circuit mode because of a spring action. The spring in the example embodiment is a torsion spring (47) but other springs that are suitable include tension or compression springs that acts on a sloping surface via a screw thread of a very high pitch, to cause the linear action of the spring to be translated into a rotating action of the barrel (13) and ring (45). Both torsion springs and compression springs can be provide a very high force, but when acting through a gearing ratio generally require less than a 1:2 ratio otherwise the gear can only be driven from one side. In this case the gear that is part of the barrel (13) acts on the ring (45) to cause a turning motion. When the diver resets the ring (45) the spring (47) is compressed. A linear motion of the ring (45) is undesirable because it changes the distance the diaphragm (27) must travel before it strikes the level (25) that controls the demand valve (31). In the example embodiment, rotating the ring (45) causes the spring (47) to be wound up or tightened, such that it exerts a pressure to unwind. When the level mechanism of (83) releases the ring (45), it rotates and carries with it the barrel (13).

A rebreather loop involves a sharp ninety degree turn in gas flow, from around the diver to a path in and out of the diver's mouth. In existing mouthpieces and bail out valves, that flow is abrupt with a wall formed by the opposing flapper valve. In preferred embodiments of the present invention, a curved surface is provided to aid that gas flow. That curved surface (7) is seen easily in FIG. 1.

The external part of the body has been simplified for clarify of understanding of the present invention. Other features common or applied to either rebreather mouthpieces or bail out valves, such a peripheral field displays, heads down displays, buzzers and speakers for audio annunciation devices can be added to the body. In the case of the speaker, both sides of the speaker should be in the gas loop: the angled presentation of the mouthpiece provides a greater space for this than in a conventional direct presentation of the gas spaces to the diver.

Retaining straps are used in conjunction with rebreather mouthpieces to keep the mouthpiece in the diver's mouth should the diver lose consciousness. Requirement for such a strap appears to be a part of the European Standard EN14143:2003. Straps are also used widely with open circuit SCUBA regulators to retain the regulator in the vicinity of the diver's mouth when not in use. Similar straps can be fitted to the present invention.

The gas supply to the valve may be from a make-up-gas cylinder, but these are usually small. Bail out cylinders are of much larger capacity. A configuration that combines the best of these is to provide the bail out gas at a lower intermediate pressure than the make-up-gas, with a one way valve in the bail out gas line. In this way, the make-up-gas is used first, but then the diver can draw on the bail out. Switching off the make-up-gas gives the diver access to the bail out gas immediately.

The example embodiment describes a bipolar action device. A tripolar action where the entire mouthpiece can be shut off can be provided using the same methods but with a secondary barrel to close the mouthpiece itself, such as a spherical barrel with a lateral as well as a rotational motion. Bail out valves of such type are commercial available.

I claim:

1. A control device comprising:
a rebreather mouthpiece,
a rebreather inhale and exhale port with a one way valve on each port,
a pneumatic demand valve,
a shut-off means for closing off the rebreather inhale port,
adjusting means for adjusting the cracking pressure of the demand valve by changing the diaphragm active area or the leverage ratio of the diaphragm to valve seat pressures synchronously with closing off or opening the rebreather inhale port.

2. A device according to claim 1 where the means to close off the rebreather inhale port also closes off the rebreather exhale port and opens an open circuit exhale port, in a synchronous manner.

3. A device according to claim 1 where the port between the diver's mouth and the internal gas space of the device is angled to enable the gas from the diver's mouth to flow at an angle between 5 degrees and 35 degrees below the horizontal into the internal gas space of the device.

4. A device according to claim 1 where there is a curved surface within the mouthpiece barrel to enable a major part of the gas going to the diver to flow from the rebreather inhale one way valve to the diver without meeting entirely a 90 degree wall, or from the diver to the exhale one way valve without the major part of the gas flow striking an obstruction at 90 degrees to the gas flow.

5. A device according to claim 1 where the shut off means for closing off the inhale rebreather port is spring loaded and has a retaining latch such that it has just two or three stable positions and cannot remain in an intermediate position without constant attention by the user.

6. A device according to claim 1 where the shut off means for closing off the inhale rebreather port is activated using a motor, including a solenoid or DC motor or AC motor or Stepper motor or Piezo motor or pneumatic device, such that a controller or safety monitor is able to close the rebreather inhale breathing path.

7. A device according to claim 1 where the diaphragm to the demand valve can be depressed or activated using a button that causes the device to be purged of water in whole or in part when a gas supply is connected and the button is depressed.

8. A device according to claim 1 with a means to mitigate the risk of free flow by using a vortex of water between an outer cover and an inner cover such that the vortex applies a pressure to a purge button that equalises in whole or in part the pressure applied to the purge button by the same water.

9. A device according to claim 1 with a means to change the maximum flow rate from the demand valve synchronously with the change from closed to open circuit, such that the maximum flow rate in open circuit is a multiple of the maximum flow rate in closed circuit.

10. A re-breather control device comprising:
a re-breather mouthpiece,
a re-breather inhale and exhale port with a one way valve on each port,
a pneumatic demand valve,
a shut-off means for closing off the rebreather inhale port, and
an adjusting means for adjusting the cracking pressure of the demand valve by changing the demand valve seat spring tension or compression synchronously with closing off or opening the rebreather inhale port.

11. A device according to claim 10 where the means to close off the rebreather inhale port also closes off the rebreather exhale port and opens an open circuit exhale port, in a synchronous manner.

12. A device according to claim 10 where the port between the diver's mouth and the internal gas space of the device is angled to enable the gas from the diver's mouth to flow at an angle between 5 degrees and 35 degrees below the horizontal into the internal gas space of the device.

13. A device according to claim 10 where the shut off means for closing off the inhale rebreather port is spring loaded and has a retaining latch such that it has just two or three stable positions and cannot remain in an intermediate position without constant attention by the user.

14. A device according to claim 10 where the shut off means for closing off the inhale rebreather port is activated using a motor, including a solenoid or DC motor or AC motor or Stepper motor or Piezo motor or pneumatic device, such that a controller or safety monitor is able to close the rebreather inhale breathing

15. A re-breather control device comprising:
a re-breather mouthpiece,
a re-breather inhale and exhale port with a one way valve on each port,
a pneumatic demand valve,
a shut-off means for closing off the rebreather inhale port, and
an adjusting means for adjusting the cracking pressure of the demand valve by changing the orifice that applies an intermediate pressure to the demand valve seat, synchronously with closing off or opening the rebreather inhale port.

16. A device according to claim 15 where the port between the diver's mouth and the internal gas space of the device is angled to enable the gas from the diver's mouth to flow at an angle between 5 degrees and 35 degrees below the horizontal into the internal gas space of the device.

17. A device according to claim 15 where there is a curved surface within the mouthpiece barrel to enable a major part of the gas going to the diver to flow from the rebreather inhale one way valve to the diver without meeting entirely a 90 degree wall, or from the diver to the exhale one way valve without the major part of the gas flow striking an obstruction at 90 degrees to the gas flow.

18. A device according to claim 15 where the diaphragm to the demand valve can be depressed or activated using a button that causes the device to be purged of water in whole or in part when a gas supply is connected and the button is depressed.

19. A device according to claim 15 with a means to mitigate the risk of free flow by using a vortex of water between an outer cover and an inner cover such that the vortex applies a pressure to a purge button that equalises in whole or in part the pressure applied to the purge button by the same water.

20. A device according to claim 1 with a means to change the maximum flow rate from the demand valve synchronously with the change from closed to open circuit, such that the maximum flow rate in open circuit is a multiple of the maximum flow rate in closed circuit.
